(19) United States
(12) Patent Application Publication
(10) Pub. No.: US 2009/0098507 A1
(43) Pub. Date: Apr. 16, 2009

(54) Ultrasonic Handpiece

(75) Inventor: Udo Kirstgen, Ingersheim (DE)

Correspondence Address: FACTOR & LAKE, LTD, 1327 W. WASHINGTON BLVD., SUITE 5G/H, CHICAGO, IL, 60607, US

(73) Assignee: DUERR DENTAL GMBH & CO KG, Bietigeim-Bissingen (DE)

(21) Appl. No.: 12/251,111

(22) Filed: Oct. 14, 2008

(30) Foreign Application Priority Data
Oct. 15, 2007 (DE) 10 2007 049 514.7

(51) Int. Cl. A61C 3/03

(52) U.S. Cl. 433/119

(57) ABSTRACT

An ultrasonic handpiece, in particular for dental and medical applications, has a drive unit for moving a tool via a coupling head. A supply device for abrasive working fluid comprises a flexible tube, one end of which is connected to a supply duct running in the drive unit and the discharge end of which is positioned in a guiding bore of clip-like design of the coupling head.

### RELATED APPLICATIONS

This application claims the filing benefit of German Patent Application No. 10 2007 049 541.7, filed Oct. 15, 2007; the content of which is incorporated herein by reference.

### TECHNICAL FIELD

The invention relates to an ultrasonic handpiece, in particular for dental and medical applications, having a drive unit for the oscillatory driving of a tool via a coupling head, and having supply means, directed towards the tool, for a working fluid, wherein an end section of the supply device is exchangeable.

### BACKGROUND OF THE INVENTION

Ultrasonic handpieces of this type are used for dental purposes, in particular for the removal of plaque. An ultrasonic handpiece of the generic type is known from DE 10 2005 044 074 A1. The drive unit serves to provide a high-frequency oscillating movement in a frequency range of a few 100 Hertz up to 50 kHz and above. To this end, the drive unit has at least one drive element made of a piezoelectric or magnetostrictive material, which generates a linear oscillating movement when an alternating voltage or an oscillating magnetic field is applied.

The oscillating movement is transmitted to a working head which serves to deflect and optionally convert the linear oscillating movement. That is to say that the linear oscillating movement transmitted in a first spatial direction is converted into an oscillating movement, favourable for the application of the tool, in a second spatial direction or optionally into a pivoting movement.

The working head is assigned a supply device for a working fluid, in particular for a mixture of water and abrasive particles. The supply device discharges the working fluid in the direction of the tool surface.

In the case of an ultrasonic handpiece available on the market, the supply device comprises a small rigid nozzle which is screwed into a threaded bore at the end of a supply duct. This nozzle gets blocked easily and can be exchanged only with difficulty.

The present invention is directed to addressing these and other matter.

### SUMMARY OF THE INVENTION

An object of the invention is to improve an ultrasonic handpiece with regard to the operational reliability and user friendliness of the supply device for the working fluid.

This object may be achieved by an ultrasonic handpiece having a drive unit for the oscillatory driving of a tool via a coupling head, and having supply means, directed towards the tool, for a working fluid, wherein an end section of the supply device is exchangeable.

The exchangeability, according to the invention, of the end section enables an exchange of the most fault-prone region of the supply device. In the event that the end section is constricted or clogged with dried-up working fluid, simple removal of the end section for cleaning or exchange for a new end section can be carried out.

In one aspect of the present invention, the end section of the supply device can be simply adapted to the geometrical conditions in the working head and does not have to be preshaped. The elasticity of the end section reduces or prevents pronounced contact with the working head, as a result of which the latter could be damped. The flexible materials used are preferably elastomers, in particular silicone materials.

In another aspect of the present invention, the end section can be simply exchanged by uncoupling from a coupling piece of the supply device. The coupling piece preferably has a substantially cylindrical outer contour, and the flexible end section can be pushed onto it.

In yet another aspect of the present invention, the flexible end section is held in a guiding bore and thus a predeterminable outflow direction for the working fluid can be maintained. At the same time, it is ensured that the working fluid is discharged very close to the tool and predominantly reaches the latter or the surface to be machined.

In a still further aspect of the present invention, the working fluid jet strikes a surface of the tool in the vicinity of the tool-clamping head or directly strikes the working region of the tool and then moves on the area that it has struck into the engagement region between the tool and the surface to be machined. This, too, ensures efficient utilisation of the working fluid without great losses.

In yet a still further aspect of the present invention the wall of the guiding bore forms a C-shaped clip, thereby enabling simple lateral insertion of the exchangeable end section of the supply device.

In an additional aspect of the present invention, a captive connection of the free end of the exchangeable end section to the coupling head is obtained in a simple manner.

In another additional aspect of the present invention, the exchangeable end section is positioned at the discharge end, but not connected to the coupling body in an appreciably oscillatory manner, so that the coupling body is not appreciably damped.

Yet another further aspect of the present invention serves to keep a damping of the coupling body low and furthermore facilitates an adaptation of the geometry of the exchangeable end section to the position and orientation of the inlet-side connection point and the guiding bore.

A still further aspect of the present invention provides a simple and inexpensive production of the exchangeable end section.

Yet another aspect of the present invention is distinguished by small dimensions in the direction perpendicular to the axis of the drive unit—this is preferably at the same time the axis of a handle of the handpiece. Moreover, the working fluid can thus also cool the drive unit.

Another further aspect of the present invention provides easy fitting and removal of the exchangeable end section.

Yet another aspect of the present invention serves to securely fasten the tube to the tube connecting piece. In this regard, the tube connecting piece has one or more circumferential securing ribs which ensure reliable, non-positive locking of the flexible end section.

Yet another further aspect of the present invention enables minimisation of the oscillation damping of the coupling head caused by the end section and also reduces local heating of the end section which otherwise occurs due to undesired input of ultrasonic energy.

In a still further aspect of the present invention, the coupling section of the end section is self-supporting and requires no support whatsoever. This is due in particular to the fact that the radius of the coupling section is larger than the radius of the outlet section. The end section is thus received in the coupling head with little or no contact.

And in yet a still further aspect of the present invention, The development according to Claim 17 has the advantage that the outlet section comes into contact with the guiding bore of the coupling head only to a small extent or not at all and thus oscillation damping of the coupling head is avoided. The radius of the outlet section is preferably smaller than the radius of the guiding bore at least by an oscillation amplitude occurring locally at the guiding bore, so that on correct mounting of the end section on the tube connecting piece there is no contact between the outlet section and the guiding bore.

These and other objects and advantages will be made apparent from the following brief description of the drawings and the detailed description of the invention.

### BRIEF DESCRIPTION OF THE DRAWINGS

FIG. 1 shows a perspective illustration of an ultrasonic handpiece for dental applications in a use state;

FIG. 2 shows a perspective exploded illustration of the ultrasonic handpiece according to FIG. 1;

FIG. 3 shows a longitudinal median section of the ultrasonic handpiece according to FIG. 1;

FIG. 4 shows an enlarged detail of the sectional illustration according to FIG. 3;

FIG. 5 shows a further-enlarged section through a tool-clamping head of the ultrasonic handpiece according to FIGS. 1 to 4;

FIG. 6 shows a perspective end view of the ultrasonic handpiece seen obliquely from the front, with the tool inserted;

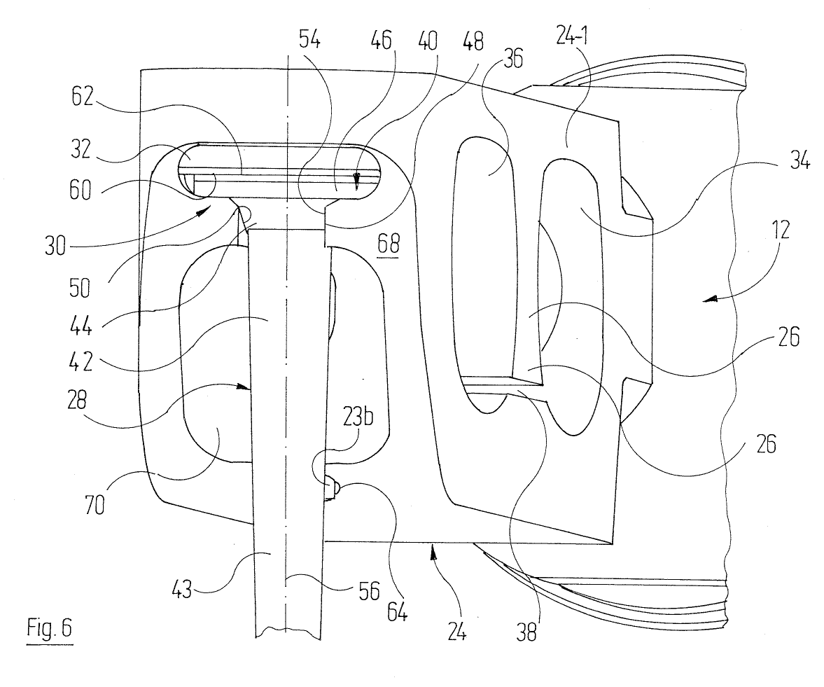

FIG. 7 shows a slightly perspective longitudinal median section through the coupling head of a further embodiment of an ultrasonic handpiece; and,

FIG. 8 shows a view from below of the ultrasonic handpiece according to FIG. 7.

### DETAILED DESCRIPTION OF THE PRESENT INVENTION

While this invention is susceptible of embodiment in many different forms, there is shown in the drawings and will herein be described in detail one or more embodiments with the understanding that the present disclosure is to be considered as an exemplification of the principles of the invention and is not intended to limit the invention to the embodiments illustrated.

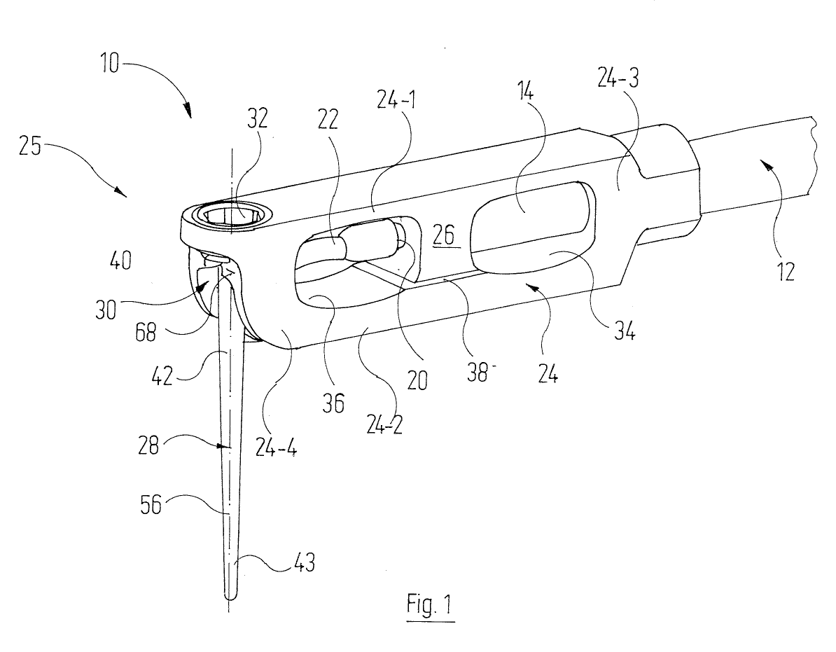

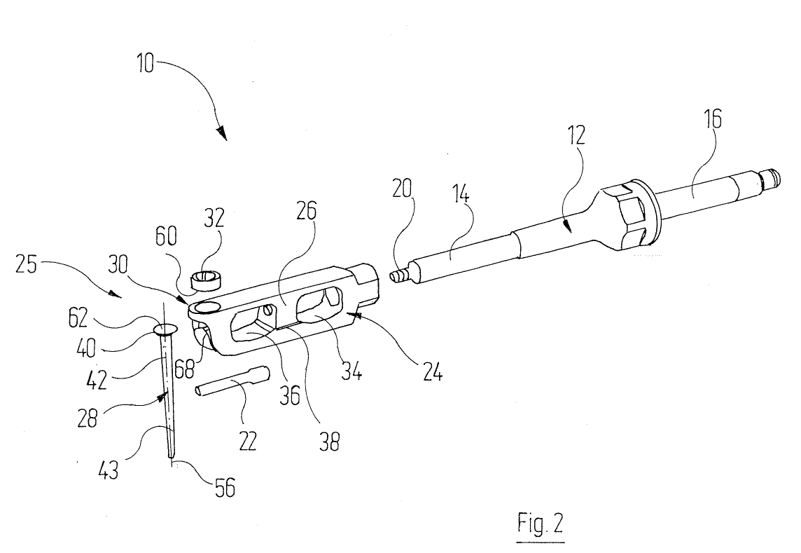

An ultrasonic handpiece 10 for dental applications illustrated in FIGS. 1 and 2 has a drive unit 12 which contains an ultrasonic oscillator (not illustrated specifically). The ultrasonic oscillator is composed of a stack of cylinder-segment-shaped, piezoelectric elements and can be electrically excited by an operating circuit (not illustrated) to generate translatory oscillating movements.

The translatory oscillating movements occur parallel to the longitudinal axis of the drive unit 12 and are transmitted to a sonotrode 14 which is connected to a piezoelectric drive 16.

Onto the end of the sonotrode 14 is screwed a deflecting head 24 which is formed in one piece, is produced from a readily oscillating metal such as titanium, and has a central coupling web 26. The translatory oscillating movement transmitted by the sonotrode 14 thus leads to a regional transverse elastic deflection of the weaker beams 24-1, 24-2, horizontal in FIG. 1, of the deflecting head 24, which beams have the same length and substantially the same cross-section.

At the same time, vertical arms 24-3 and 24-4 of the deflecting head 24, which have a greater thickness, are moved substantially perpendicularly to the longitudinal axis of the apparatus. The oscillating movement of the beam 24-4 is used to drive a tool 28 which can be attached to the end of the deflecting head 24. The beam 24-4 is designed as a clamping head 25 for this purpose.

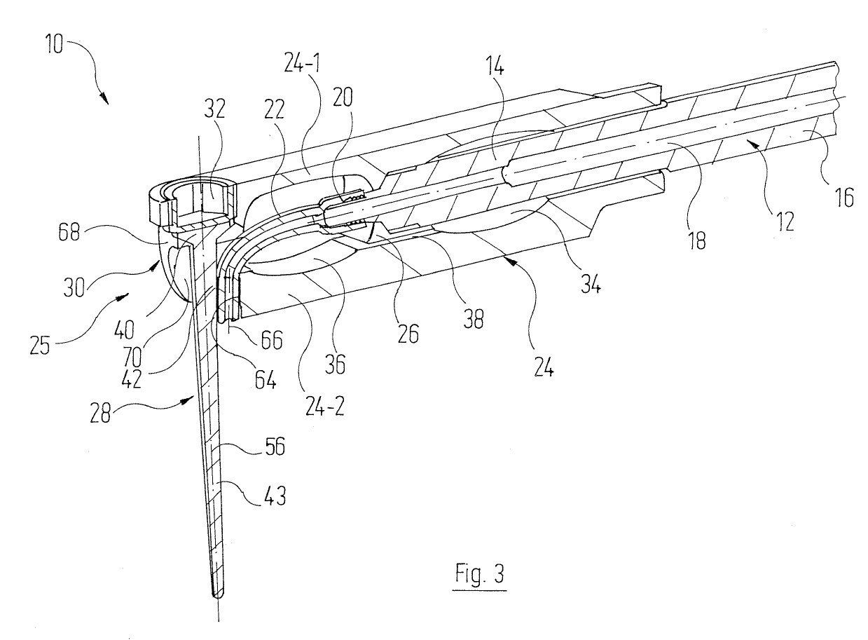

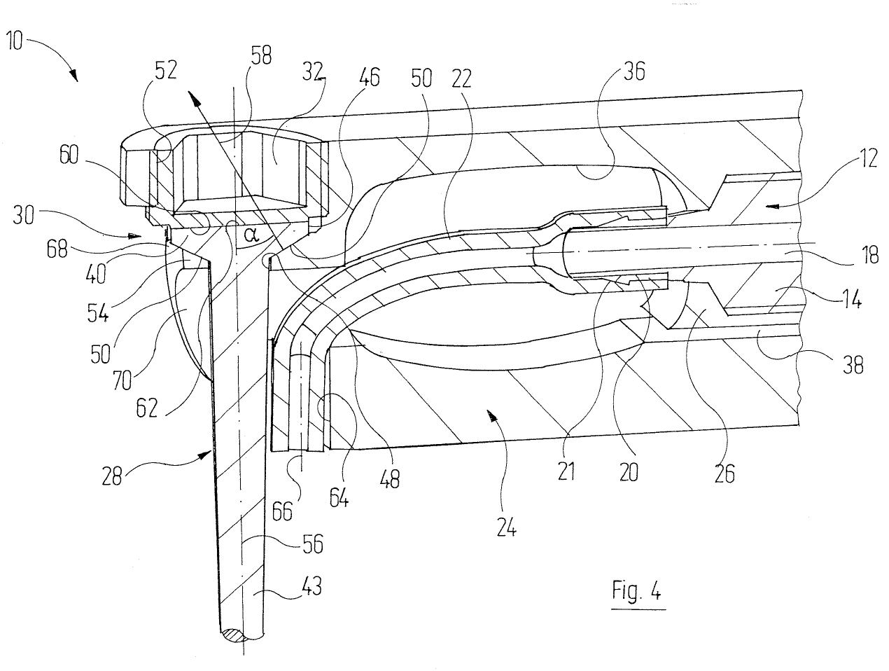

The tool 28 is in this case received in a tool holder 30, which is described in more detail below with reference to FIGS. 3 and 4. To secure the tool 28 in the tool holder there is provided a locking screw 32 which can be screwed by its external thread into a correspondingly designed internal thread 33 of the deflecting head 24.

Extending through the sonotrode 14 is an axial bore 18 (illustrated in more detail in FIG. 3) which serves as a supply duct for a working fluid. Arranged at the end of the sonotrode 14 is a tube connecting piece 20 which is in communication with the axial bore 18 and which is equipped externally with conical ribs provided to secure a tube 22 made of elastic material, as described in more detail below.

As can be seen from FIGS. 3 and 4, the deflecting head 24 is a one-piece metal part which has two openings 34, 36, each with a substantially rectangular-oval cross-section. Lying between them is the coupling web 26, which is spaced from the beam 24-2 by a through-slot 38.

Owing to the openings 34, 36 and the beams 24-1 to 24-4, and the elasticity of the metal material from which the deflecting head 24 is produced, an oscillatory frame is formed, which converts the oscillating movement of the ultrasonic oscillator, which movement occurs on the apparatus axis and is transmitted via the coupling web 26, into an oscillating movement of the tool 28, which movement is perpendicular to the apparatus axis.

The tool 28 has a cylindrical shank section 42 and a working section tapering towards the free end.

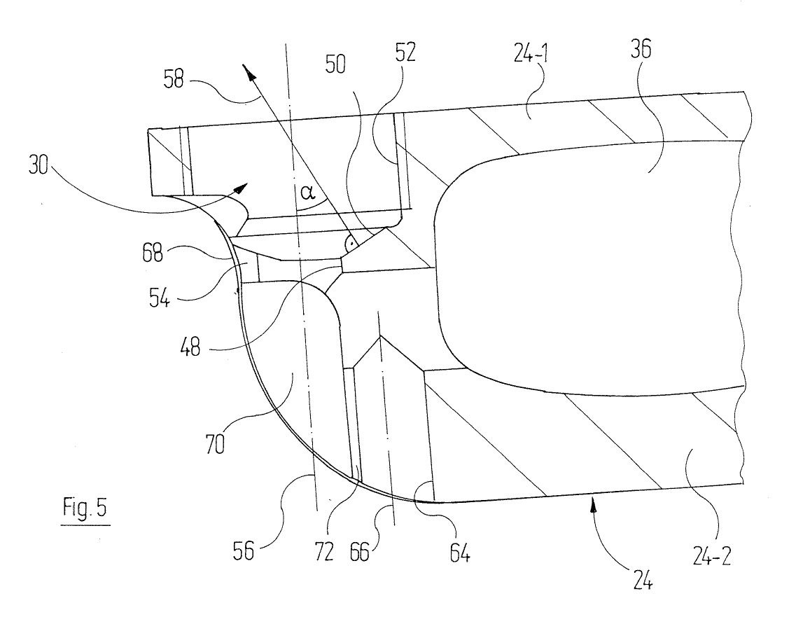

Reference will now be made in particular to FIGS. 2 to 5, which show details of the clamping head 25 and the clamping-in end of the tool 28.

To secure the tool 28 to the clamping head 25, the shank section 42 has a rotationally symmetrical shank body 40, which has a conical seating surface 44 (at the bottom in the drawing) and an adjoining cylindrical circumferential surface 46. The tool holder 30 has, for its part, a bore 48 which is adapted to the maximum diameter of the tool shank 42 and through which the tool shank 42 can be inserted.

Adjoining the bore 48 is a conical supporting surface 50 which serves as a bearing surface for the seating surface 44 of the tool 28. The supporting surface 50 merges into a threaded bore 52, which has a larger diameter than the bore 48 for the tool shank 42 and which serves to receive the locking screw 32.

In principle, the tool 28 could be removed from the tool holder 30 upwards in the drawing after removal of the locking screw 32. However, to do this, the locking screw 32 would have to be completely removed. But this is time-consuming and there is also the risk of losing the locking screw 32. Moreover, a repeated screwing-in of the locking screw 32 may lead to handling problems as regards the correct attachment of the external thread of the locking screw.

For this reason, the deflecting head 24 is provided with a removal slot 54 which has a profile designed in a manner corresponding to the longitudinal contour of the tool 28 and which runs from a front side 68 of the deflecting head 24 to the tool holder 30.

The removal slot 54 is in this case arranged such that the tool 28 can be exchanged only when the locking screw 32 has been unscrewed upwards by a considerable distance from the locking position illustrated in FIGS. 3 and 4. This prevents the tool 28 from inadvertently coming free from the tool holder in the event of poor locking of the locking screw 32 and easy loosening of the latter. The tool 28 is thus positively secured in the tool holder 30 in both axial directions, given at least almost correct or completely correct screwing on of the locking screw 32.

Given a planar contact between the locking screw 32 and the tool 28, play-free securing of the tool 28 in the tool holder 30 and frictional locking of the locking screw 32 in its locking position is ensured. For this purpose, cooperating end faces 60, 62 of locking screw 32 and tool shank 42 are both plane and perpendicular to the axis of the tool holder 30.

With the loosening of the locking screw 32, firstly the play-free fixing of the tool 28 in the tool holder 30 is undone, but without yet allowing the tool 28 to be removed through the removal slot 54. This is only possible when the locking screw 32 is deliberately brought into an unlocking position by the user, for example by rotation through a few complete revolutions, in which position at least almost the entire cross-section of the removal slot 54 is freed by the locking screw 32. Only when this is the case can the tool 28 be removed from the tool holder 30 through the removal slot 54.

In the tool holder 30, the supporting surface 50 forms a first undercut, by means of which the shank head 40 of the tool 28 can be secured in a first axial direction (towards the tip of the tool 28) parallel to its central axis 56. In this case, the supporting surface 50 cooperates with the seating surface 44.

A surface normal 58 of the supporting surface 50 forms an acute angle a with respect to the central axis 56 of tool 28 and tool holder 30.

The locking screw 32 serves for axial support of the tool 28 on the deflecting heat 24 in the second axial direction (upwards in the drawing).

The end side 60, facing the tool shank 42, of the locking screw 32 is designed as a transverse plane surface, just like the upper side 62 of the tool shank 42, and enables complete axially positive and circumferentially frictional securing of the tool 28 to the deflecting head 24. A surface normal of the end side 60 is oriented parallel to the central axis 56.

According to FIGS. 3, 4 and 5, a tube-guiding bore 64 is provided in the deflecting head 24, the central axis 66 of which bore runs parallel to the central axis 56 of the tool 28 and of the tool holder 30 and which extends from a lower side of the deflecting head 24 into the opening 36. To be more precise, this takes place via a slot 72 which is open towards the bore 48 and runs parallel to the latter.

The guiding bore 64 is accessible from the front side of the deflecting head 24 via a slot 70 constituting an extension of the removal slot 54. The slots 70 and 72 thus together form a T-shaped slot arrangement.

In the guiding bore 64 there is held an outlet-side end region of a flexible tube 22, the inlet-side end region of which is sealingly secured to the tube connecting piece 20 of the sonotrode 14. As a result of the fact that the transverse cross-section of the wall of the guiding bore 64 is C-shaped owing to the slot 72, the tube 22, which has a somewhat larger diameter than the bore 48, can be simply clipped positively into the guiding bore 64 under elastic deformation from the slot 72. As a result of a merely loose positive reception of the tube 22 in the guiding bore 64, undesired oscillation coupling of the tube 22 to the deflecting head 24 and a resulting heating of the tube 22 are avoided. This effect can be further enhanced by reducing the wall thickness of the tube from the inlet-side end towards the outlet-side end.

An optionally abrasive particle-containing working fluid can be fed through the drive unit 12 into the tube 22 and emerges into the surroundings at that end of the tube 22 which is received in the guiding bore 64.

Most of the working fluid thus strikes the tool 28 or the dental surface to be machined by the tool 28. This ensures an efficient use of the working fluid, which can thus be metered precisely to the place of use.

Demounting of the tube 22 is preferably performed by firstly removing the tool 28 from the tool holder 30 in order to free the slot 72. Then, the tube 22 is removed from the guiding bore 64 into which it has been positively clipped and now extends substantially parallel to the longitudinal axis of the deflecting head 24. The tube 22 is then pulled off forwards from the tube connecting piece 20 projecting into the opening 36.

In reverse order, a new tube 22 is firstly pushed onto the tube connecting piece 20 and then bent through 90° and clipped into the guiding bore 64.

The tube 22 is preferably produced from an elastomer, in particular a soft silicone material, i.e. a flexible plastic material. It is particularly advantageous for the wall thickness of the tube to be matched to the bending radius defined by the distance and orientation of the tube connecting piece 20 and of the guiding bore 64, so that the tube 22 does not collapse, which would obstruct the flow of the working fluid.

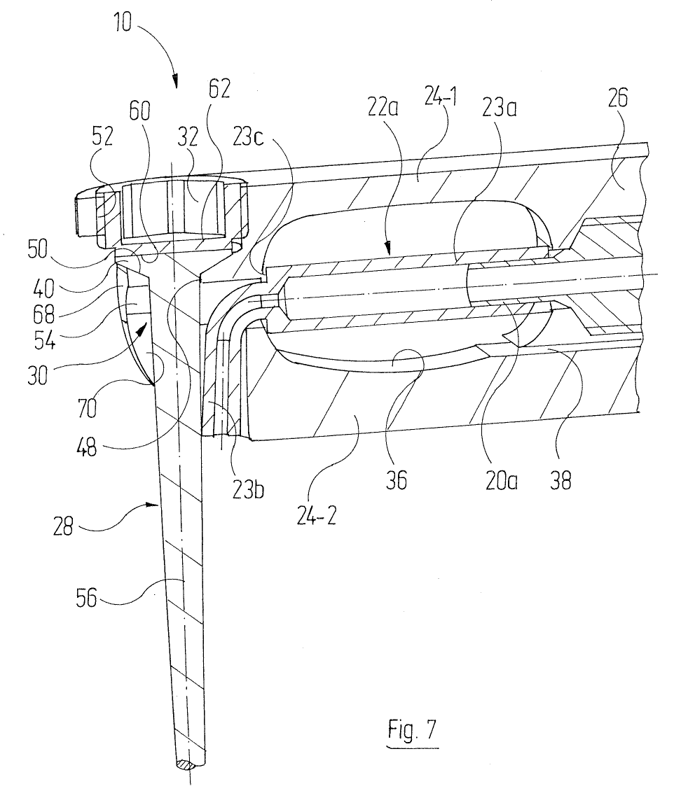

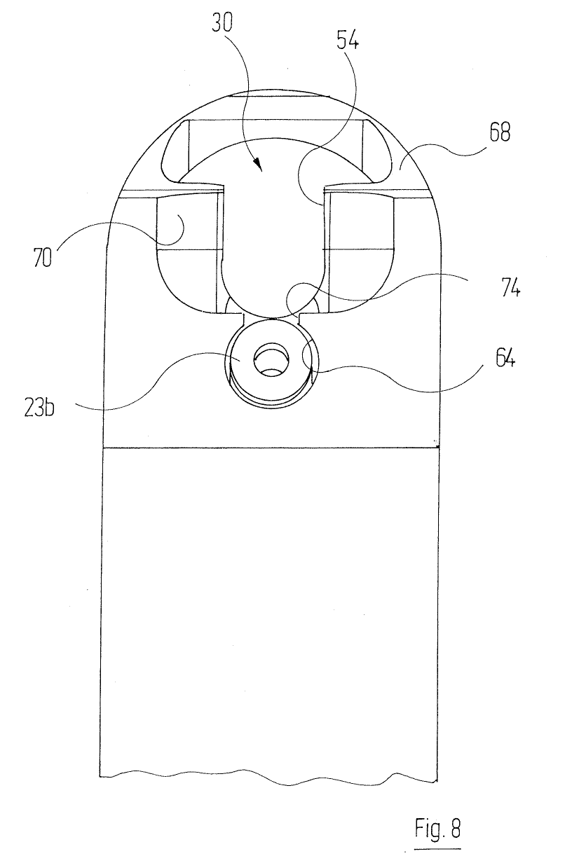

The embodiment of the tube 22a illustrated in FIGS. 7 and 8 differs from the tube 22 described above in that it has different radii or diameters in certain sections. A coupling section 23a of the tube 22a, which section is provided for fitting onto the cylinder-sleeve-shaped tube connecting piece 20a designed free of securing ribs, has an inside diameter adapted to the tube connecting piece 20a. The tube 20a can thus be pushed onto the tube connecting piece 22a in a virtually force-free manner.

The wall thickness of the coupling section 23a corresponds substantially to the wall thickness of the adjoining outlet section 23b. Owing to the larger radius or outside diameter of the coupling section 23a, the latter can span unsupported the distance up to the front end of the opening 36, despite the free length of the tube connecting piece 20a being kept short for reasons of simplified mounting, and does not require any further support on the deflecting head 24.

The outlet section 23b adjoining the coupling section 23a has a smaller outside diameter than the coupling section 23a and is already preshaped into the curvature illustrated in FIG. 7, in order to ensure an as far as possible contactless reception in the guiding bore 64. The wall thicknesses of the coupling section 23a and of the outlet section 23b are chosen to be at least substantially equal.

The preshaped design of the tube 22a results in a locking against rotation, so that during operation of the ultrasonic handpiece 10 no undesired rotation of the tube 22a relative to the tube connecting piece 20a is to be expected.

With the cylinder-sleeve-shaped tube connecting piece 20a designed free of securing ribs, simple fitting and removal of the tube 22a is ensured, since there is no need for any local deformation of the coupling section 23a in order to push it onto the tube connecting piece 20a. The axial length of the coupling section 23a is dimensioned such that, when the tube is fully pushed onto the tube connecting piece 20a, an air gap is present between an end face 23c of the coupling section 23a and the inner surface of the opening 36. This air gap is dimensioned in such a way that, even at a maximum amplitude of the deflecting head 24, there is no contact, or at least no appreciable contact, between the end face 23c and the deflecting head 24. Undesired transmission of ultrasonic energy from the deflecting head 24 to the tube 22a is thereby reduced or prevented.

After inserting the tool 28 into the deflecting head 24, removal from the opening is prevented by means of the geometry of the coupling section 23a, since the integrally formed-on, bent outlet section 23b is received in such a manner in the tube-guiding bore 64 closed off regionally by the tool 28 that no escape is possible.

The shaping of the tube-guiding bore 64 can be seen in FIG. 8, the bore adjoining the slot 70 and enabling removal of the tube 22a by bending back the angled outlet section 23b in the direction of the axis of the coupling section 23a. In order to avoid damage of the outlet section 23b, the gap 74 formed between the slot 70 and the tube-guiding bore 64 is formed with wall sections oriented parallel to one another, so that there are no sharp edges. It is also evident from FIG. 8 that the outlet section 23b has a smaller outside diameter than the tube-guiding bore 64, in order to avoid transmission of ultrasonic energy from the deflecting head 24 to the tube 22a.

In a further embodiment of the invention (not illustrated), the tube 22 may be provided with a reinforcing material integrated in the tube material, in particular a reinforcing fabric made of plastic or wire mesh, in order to ensure a free passage of the working fluid even with small bending radii.

While the deflecting head 24 is preferably produced from the particularly tough and high-strength material titanium, the material used for the locking screw 32 is bronze, brass or a plastic material with high density, in particular polytetrafluoroethylene (PTFE), polyaryl ether ketone (PAEK) or polyethyl ether ketone (PEEK).

In an embodiment of the invention (likewise not illustrated), the tool and the locking screw are designed in one piece with one another. This enables a quick tool change and reliable, positive securing of the tool to the deflecting head.

It is again emphasized that the above-described embodiments of the present invention, particularly, any “preferred” embodiments, are possible examples of implementations merely set forth for a clear understanding of the principles of the invention. Many variations and modifications may be made to the above-described embodiments of the invention without substantially departing from the spirit and principles of the invention. All such modifications are intended to be included herein within the spirit of the invention and the scope of protection is only limited by the accompanying claims.

What is claimed is:

1. An ultrasonic handpiece comprising a drive unit for the oscillatory driving of a tool via a coupling head, and having supply means, directed towards the tool, for a working fluid, wherein an end section of the supply device is exchangeable.

2. The ultrasonic handpiece of claim 1, wherein the exchangeable end section is produced from a flexible material.

3. The ultrasonic handpiece of claim 1, wherein the exchangeable end section is coupled to a fixed coupling piece of a substantially rigid supply line of the supply device.

4. The ultrasonic handpiece of claim 1, wherein at least one guiding bore for receiving a section of the exchangeable end section is provided in the coupling head, so that a material web remaining between tool holder and guiding bore has a thickness of approximately 0.2 mm to 2 mm.

5. The ultrasonic handpiece of claim 4, wherein a central axis of the guiding bore is oriented at an angle less than 30 degrees to the main axis of the tool.

6. The ultrasonic handpiece of claim 4, wherein the guiding bore has at least one radial outwardly open slot running substantially parallel to the central axis.

7. The ultrasonic handpiece of claim 6, wherein the width of the slot is less than the diameter of the exchangeable end section.

8. The ultrasonic handpiece of claim 1, wherein the guided section of the exchangeable end section is received in an at least substantially force-free manner in the guiding bore.

9. The ultrasonic handpiece of claim 1, wherein the wall thickness of the exchangeable end section decreases towards the free end.

10. The ultrasonic handpiece of claim 1, wherein the exchangeable end section is an injection-moulded part.

11. The ultrasonic handpiece of claim 1, wherein the supply device comprises a duct which extends preferably centrally through the drive unit.

12. The ultrasonic handpiece of claim 1, wherein a clamping head holding the tool has an outwardly open slot, through which the exchangeable end section can be moved.

13. The ultrasonic handpiece of claim 2, wherein the coupling piece has one or more circumferential securing ribs which ensure a reliable, non-positive locking of the flexible end section on the coupling piece.

14. The ultrasonic handpiece of claim 1, wherein the exchangeable end section is preshaped in such a way that it is received in an at least substantially force-free, preferably contactless, manner in the guiding bore (64) of the coupling head (24).

15. The ultrasonic handpiece of claim 1, wherein the exchangeable end section has a coupling section with an enlarged diameter, the longitudinal extent of which is adapted at least substantially to the size of an opening, provided adjacent to the tool holder, of the coupling head.

16. The ultrasonic handpiece of claim 15, wherein an air gap is present between an end face of the coupling section and the coupling head, with a gap width greater than the local oscillation amplitude of the coupling head.

17. The ultrasonic handpiece of claim 16, wherein an outlet section is of curved shape and has a smaller outside diameter than the guiding bore.

18. The ultrasonic handpiece of claim 15, wherein an outlet section is of curved shape and has a smaller outside diameter than the guiding bore.
